(19) United States
(12) Patent Application Publication
(10) Pub. No.: US 2019/0196059 A1
(43) Pub. Date: Jun. 27, 2019

(54) METHOD FOR MODELING A SEDIMENTARY BASIN

(71) Applicant: IFP Energies nouvelles, Rueil-Malmaison Cedex (FR)

(72) Inventors: Mathieu DUCROS, RUEIL-MALMAISON (FR); Isabelle FAILLE, CARRIERES SUR SEINE (FR); Sylvie PEGAZ-FIORNET, MARLY-LE-ROI (FR); Renaud TRABY, L'ETANG LA VILLE (FR); Francoise WILLIEN, RUEIL MALMAISON (FR); Sylvie WOLF, RUEIL MALMAISON (FR)

(21) Appl. No.: 16/224,381

(22) Filed: Dec. 18, 2018

(30) Foreign Application Priority Data
Dec. 22, 2017 (FR) 17/62.936

(51) Int. Cl. G01V 99/00

(52) U.S. Cl. CPC G01V 99/005; G06F 2217/16

(57) ABSTRACT

The invention relates to a method for modeling a sedimentary basin, said sedimentary basin having undergone a plurality of geological events defining a sequence of states {Aᵢ} of the basin, each of said states extending between two successive geological events, the method comprising the implementation by data processing means (21) of steps of:
(a) Obtaining measurements of physical quantities of said basin, which are acquired from sensors (20);
(b) For each of said states Aᵢ, constructing a meshed representation of said basin depending on said measurements of physical quantities;
(c) For each of said states Aᵢ, and for each cell of said meshed representation, computing an overpressure in the cell at the end of the state Aᵢ by solving an equation of the Darcy equation type;

characterized in that step (c) comprises a prior step (c).0 of verifying that for at least one of said cells the overpressure has changed during the state Aᵢ by more than a first preset threshold, and implementing the rest of step (c) only if this is verified.

### CROSS REFERENCE TO RELATED APPLICATIONS

Reference is made to French Application No. 17/62.936 filed Dec. 22, 2017, which is incorporated herein by reference in its entirety.

### BACKGROUND OF THE INVENTION

### Field of the Invention

The present invention relates to a method for modeling a sedimentary basin.

### Description of the Prior Art

Tools for “modeling basins” that allow the formation of a sedimentary basin to be simulated numerically are known. By way of example, tools are described in EP2110686 corresponding to U.S. Pat. No. 8,150,669 or in patent applications EP2816377 corresponding to US published application 2014/0377872, EP3075947 corresponding to US published application 2016/0290107, EP3182176 corresponding to US published application 2017/0177764.

These computational tools allow all of the sedimentary, tectonic, thermal, hydrodynamic and organic and inorganic chemical processes that are involved in the formation of a sedimentary basin to be simulated in one, two or three dimensions.

Numerical modeling of sedimentary basins is an important tool for the exploration of the bedrock and in particular oil and gas exploration. One of its objectives is predicting the pressure field at the scale of the sedimentary basin based in particular on geological and geophysical information and on drilling data. In the context of oil and gas exploration, the data that allows such models to be constructed generally originates from
appraisals and geological studies for evaluating the oil and gas potential of the sedimentary basin, which are carried out based of available data (outcrops, seismic campaigns, drilling campaigns). Such appraisals are directed to obtaining:
   Better understanding the architecture and geological history of the bedrock, and in particular to study of whether hydrocarbon migration and maturation processes were able to occur;
   Identifying the regions of the bedrock in which these hydrocarbons could have accumulated;
   establishing which regions have the best economic potential, evaluated based on the volume and the nature of the probably trapped hydrocarbons (viscosity, degree of mixture with water, chemical composition, etc.), and their development cost (dependent for example on depth and fluid pressure).
exploration wells drilled into the various regions having the best potential, in order to confirm or disprove the potential estimated beforehand, and to acquire new data to enable new, more precise studies.

Conventionally, basin modeling algorithms include three main steps:
1. a phase of constructing a mesh of the bedrock under an assumption as to its internal architecture and as to the properties that characterize each cell: for example their porosity, their sedimentary nature (clay, sand, etc.) or even their organic material content at the moment of their sedimentation. The construction of this model is based on data acquired via seismic campaigns or well measurements for example. This mesh is structured into layers: a group of cells is assigned to each geological layer of the model basin.
2. a phase of reconstructing the mesh, representing prior states of the architecture of the basin. This step is carried out using, for example, a back stripping method (Steckler, M. S., and A. B. Watts, Subsidence of the Atlantic-type continental margin off New York, Earth Planet. Sci. Lett., 41, 1-13, 1978.) or a structural restoration method as described in the aforementioned patent application EP2110686 corresponding to U.S. Pat. No. 8,150,5669.
3. a step of numerically simulating a selection of physical effects that occur during the evolution of the basin and that contribute to the formation of oil and gas traps. This step is based on a representation of time discretized into “events”, with each event being simulated by a succession of time intervals. The start and end of an event correspond to two successive states of the evolution of the architecture of the basin delivered in the preceding step 2. The number of time intervals, which is generally comprised between a few and several hundred, may be set, or vary to match the complexity of the geological and physical mechanisms.

It is desirable to use the briefest possible time intervals in order to improve, as much as possible, the quality of the model and its representativeness of reality (this is of major importance to be able subsequently in particular to proceed with oil and gas wells), but such an approach is rapidly limited by the capacity and resources of present-day processors.

Even when expensive supercomputers are used, the time required to model a basin is substantial.

It would be desirable to improve the computational efficiency of current methods so as to be able to implement them, without loss of quality, on everyday hardware in a reasonable time.

The invention is directed to improving this situation.

### SUMMARY OF THE INVENTION

The invention provides, according to a first aspect, a method for modeling a sedimentary basin, the sedimentary basin having undergone a plurality of geological events defining a sequence of states {Aᵢ} of the basin, each of the states extending between two successive geological events, the method comprising the implementation by data processing steps of:
(a) Obtaining measurements of physical quantities of the basin, which are acquired from sensors;
(b) For each of the states Aᵢ, constructing a meshed representation of the basin depending on the measurements of the physical quantities;
(c) For each of the states Aᵢ, and for each cell of the meshed representation, computing an overpressure in the cell at the end of the state Aᵢ by solving an equation of the Darcy equation type;
   characterized in that step (c) comprises a prior step (c).0 of verifying that for at least one of the cells the overpressure has changed during the state Aᵢ by more than a first preset threshold, and implementing the rest of step (c) only if this is verified.

According to the invention, step (c) may also thus be read:
(c) For each of the states Aᵢ, and for each cell of the meshed representation: c(0) a first overpressure in the cell is computed under an assumption of hydrostatic pressure, and if the first overpressure has changed during the state Aᵢ by more than a first preset threshold in the cell, computing a second overpressure in the cell at the end of the state Aᵢ by solving a law expressing the flow rate of a fluid filtering through a porous medium.

The method according to the invention is advantageously completed by the following features, implemented alone or in any technically possible combination thereof:

Step (c).0 comprises computing a value of the theoretical overpressure that would develop in the cell under the assumption of a hydrostatic pressure;

The value of the theoretical overpressure that would develop in the cell under the assumption of a hydrostatic pressure is obtained using formula

$$V = q \times Δ t \times S = \frac{V}{Δ \tilde{σ}} \times oP + \frac{k}{μ} \times S \times \frac{{oP}^{i}}{d} \times Δ t ,$$

with:
q is the Darcy or filtration speed;
oPⁱ is the theoretical overpressure generated during the state Aᵢ;
μ is the dynamic viscosity of water;
S is the area of the cell normal to the vertical axis;
d is the distance between the center of the cell and the center of the top face of the cell;
g is the norm of the acceleration due to gravity vector; and
Δt is the duration of the state in question.

step (c).0 furthermore comprises verifying that for at least one of the cells the overpressure has changed, from the last state A_{j,j<i} in which the rest of step (c) was implemented, by more than a second preset threshold;

step (c).0 comprises computing, for each cell, an indicator:
If for each cell the computed value of the theoretical overpressure that would develop in the cell under the assumption of a hydrostatic pressure is lower than the first threshold, each indicator is incremented by the computed value of the theoretical overpressure that would develop in the cell under the assumption of a hydrostatic pressure;
If for at least one cell, the computed value of the theoretical overpressure that would develop in the cell under the assumption of a hydrostatic pressure is lower than the first threshold or the value of the indicator is higher than the second threshold, each indicator is reset to zero.

The method comprises a step (d) of selecting regions of the basin corresponding to cells of the meshed representation of the basin at the current time containing hydrocarbons;

step (d) comprises developing the basin depending on the selected regions;

step (b) is implemented by backstripping or structural reconstruction;

step (c) comprises:
1. computing an effective stress applied to the cell at the end of the state Aᵢ;
2. computing an overpressure in the cell at the end of the state Aᵢ depending on the effective stress computed at the end of the state Aᵢ.

the effective stress at the end of the state Aᵢ for a cell is computed depending on the effective stress at the end of the preceding state Aᵢ₋₁ and on an additional effective stress on the state Aᵢ dependent on a change in sediment thickness during the state Aᵢ;

step b) comprises, for each cell and each state Aᵢ, determining a total vertical stress on the cell, the additional effective stress being computed in step (c) to be the additional total vertical stress Aᵢ with respect to the preceding state Aᵢ₋₁, minus the hydrostatic pressure equivalent to the change in sediment thickness;

step (c).2 comprises computing a rate of change in the effective stress during the state Aᵢ depending on the effective stress at the end of the state Aᵢ and on the effective stress at the end of the preceding state Aᵢ₋₁;

step (c).2 comprises computing a rate of change in a porous volume of the cell during the state Aᵢ while assuming the rate of change in the effective stress during the state Aᵢ is constant, to obtain the overpressure at the end of the state Aᵢ by solving a simplified Darcy equation;

the simplified Darcy equation is given by the formula

$$\frac{{Vol}_{s , k}}{Δ t} {c}_{k} ( {oP}_{k}^{i} - {oP}_{k}^{i - 1} ) + {\int }_{δ k}^{ } \frac{- K}{μ} \vec{grad} {oP}_{k}^{i} \cdot {\vec{n}}_{k} = - \frac{{Vol}_{s , k}}{Δ t} Δ \tilde{σ} {ϵ}_{k} ,$$

with
Cₖ is the change in void density (porous volume over solid volume) over the change in effective stress under the assumption of hydrostatic pressure;
Vol_{s,k} is the solid volume of the cell k in question;
μ is the kinematic viscosity of the fluid;
K is the intrinsic permeability of the rock;
Δt is the duration of the state in question;
oPⁱ is the overpressure at the end of state Aᵢ; and
Δ\tilde{σ}ϵ is the theoretical additional effective stress.

According to a second aspect, the invention relates to equipment for modeling a sedimentary basin, the sedimentary basin having undergone a plurality of geological events defining a sequence of states {Aᵢ} of the basin, each event extending between two successive geological events, the equipment comprising data processors configured to:
Obtain measurements of physical quantities of the basin, which are acquired from sensors;
For each of the states Aᵢ, constructing a meshed representation of the basin depending on the measurements of physical quantities;
For each of said states Aᵢ, and for each cell of the meshed representation, verifying that for at least one of the cells an overpressure has changed during the state Aᵢ by more than a first preset threshold, and if this is verified computing the overpressure in the cell at the end of the state Aᵢ by solving a Darcy equation.

According to a third aspect, the invention relates to a computer program product stored in a tangible recording medium downloadable from at least one of a communication network, recorded on a medium that is readable by computer, and executable by a processor, comprising program code instructions for implementing the method according to the first aspect of the invention, when the program is executed on a computer.

### DESCRIPTION OF THE DRAWINGS

Other features, goals and advantages of the invention will become apparent from the following description, which is purely illustrative and nonlimiting, and which must be read with reference to the appended drawings, in which:

FIG. 1 is a diagram showing the pressure as a function of depth in an exemplary sedimentary medium;

FIG. 2a schematically shows a known method for modeling a sedimentary basin;

FIG. 2b schematically shows the method for modeling a sedimentary basin according to the invention;

FIG. 2c schematically shows the method for modeling a sedimentary basin according to a preferred embodiment of the invention;

FIG. 3 illustrates the decoupling between the determination of the effective stress and the determination of the overpressure;

FIG. 4 shows a system architecture for implementing the method according to the invention;

FIG. 5 shows an example of smoothing of a porosity/stress curve;

FIGS. 6a and 6b show two examples of modeling of a sedimentary basin without and with the method according to the invention.

### DETAILED DESCRIPTION OF THE INVENTION

### Principle of the Invention

A basin model delivers a predictive map of the bedrock in particular indicating the pressure in the basin (pressure field) over its geological history.

To do this, a substantial part of the computing time of the iterative simulating portion is related to the modeling of the effects of water flow in the basin.

The equilibrium pressure that is established in the pores of a porous medium if there is a sufficiently permeable path joining the point of study to the surface is referred to as hydrostatic pressure. It is also the pressure that would be obtained in a water column at the same depth.

Lithostatic pressure is a generalization to solid rocky media of the concept of hydrostatic pressure, which applies to gaseous and liquid media. It is the pressure that would be obtained in a column of rock at the same depth.

The lithostatic and hydrostatic gradients correspond to the variation in the lithostatic and hydrostatic pressures per unit of depth.

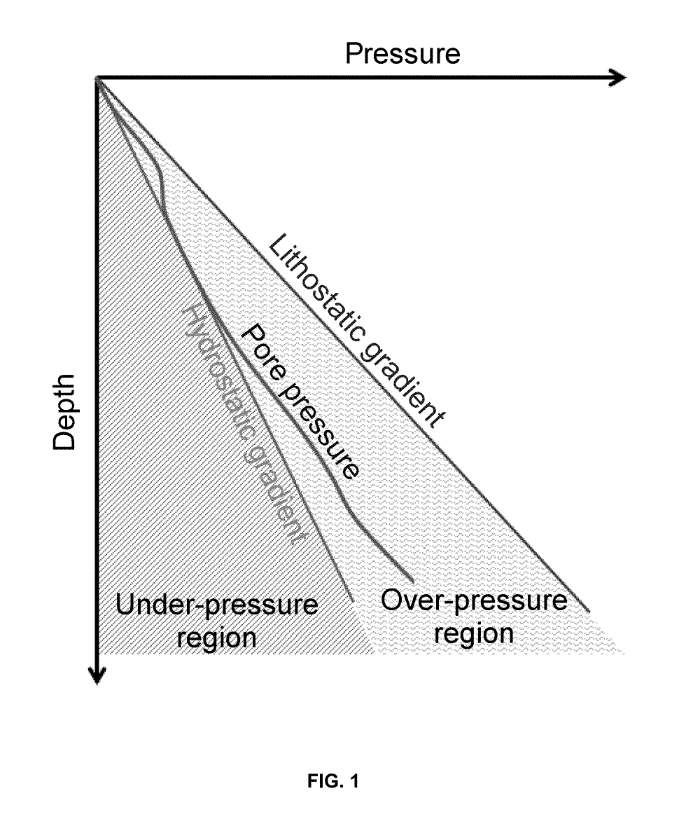

With reference to FIG. 1 it may be seen that the fluid pressure observed in the pores of the rock (called observed pore pressure) generally varies in the same way as the hydrostatic pressure. However, under certain geological conditions, the pore pressure may diverge from this normal behavior.

The difference between the pore pressure and the hydrostatic pressure is referred to as overpressure/under-pressure (the regions of overpressure and under-pressure are shown in FIG. 1).

Specifically, sedimentary basins are, with some notable exceptions, accumulations of gas or hydrocarbons saturated with water. The process of sedimentation and erosion however leads to changes, over the course of geological time, in the vertical load in sedimentary basins. These changes in load induce compaction or expansion of the rocks, effects responsible for the movement of the fluids that they contain, generally relatively brackish water. If the permeability of the rocks allows fluids to flow, the pressure remains at hydrostatic equilibrium, but diverges therefrom in the contrary case. The pore pressure may therefore be higher (overpressure) or lower (under-pressure) than the hydrostatic pressure when, for example, the permeability does not allow water to easily flow within the rock.

Various effects may be the origin of overpressures (Grauls, D., Overpressure assessment using a minimum principal stress approach—Overpressures in Petroleum Exploration; Proc Workshop, Paul, April 1998—Bulletin du centre de recherche Elf Exploration et Production, Mémoire 22, 137-147, ISSN: 1279-8215, ISBN: 2-901 026-49-4). Major effects for example include:
Compaction disequilibrium: during a sedimentation episode, the sedimentary field is subjected to an increase in lithostatic stress (due to the increase in the weight of the superjacent rocks). The porosity of the rocks decreases, leading to an increase in the pressure of the fluid present in the porous medium. However, if the fluid is free to flow, it will tend to evacuate in order to return to hydrostatic pressure. There is therefore competition between the speed of expulsion of the fluid and the capacity of the rock to compact. However, the lower the permeability, the greater the diffusion time of the fluid. For a given sedimentation rate, there is therefore a critical permeability below which overpressure is developed.
Expansion of the fluids: Under the effect of a temperature increase, the fluid tends to expand. At constant pore volume, pressure then increases.
A source of internal fluids: certain mineral reactions, such as the conversion of smectite to illite, generate water. Moreover, maturation of the source rock, the origin of hydrocarbons, converts a solid into fluid (organic porosity or secondary porosity is then spoken of). In both these cases, fluid is generated at depth and therefore overpressures develop.

To determine the water flow and pressures that result therefrom at the present time, it is necessary to simulate the water flow over the sedimentary history of the basin in the iterative step.

To do this, the fluid flows are computed using the conventional Darcy law:

$$u = - \frac{K}{μ} ( \vec{grad} P - ρ \vec{g} )$$

with u the speed of movement of the fluid (of the water in the case of modeling of sedimentary basins) in the medium, K the permeability of the medium to the fluid in question, μ the viscosity of the fluid and ρ its density, g the acceleration due to gravity, and P the pore pressure.

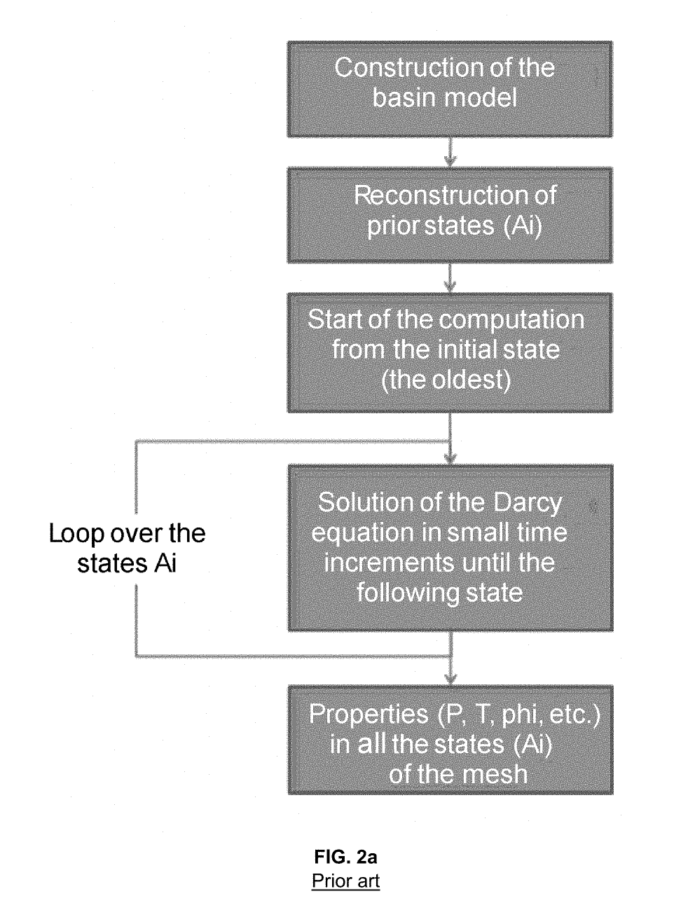

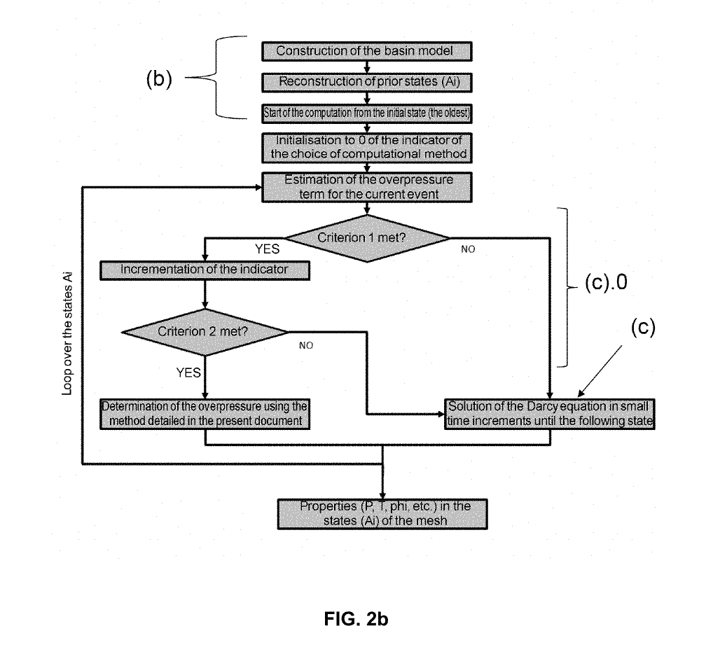

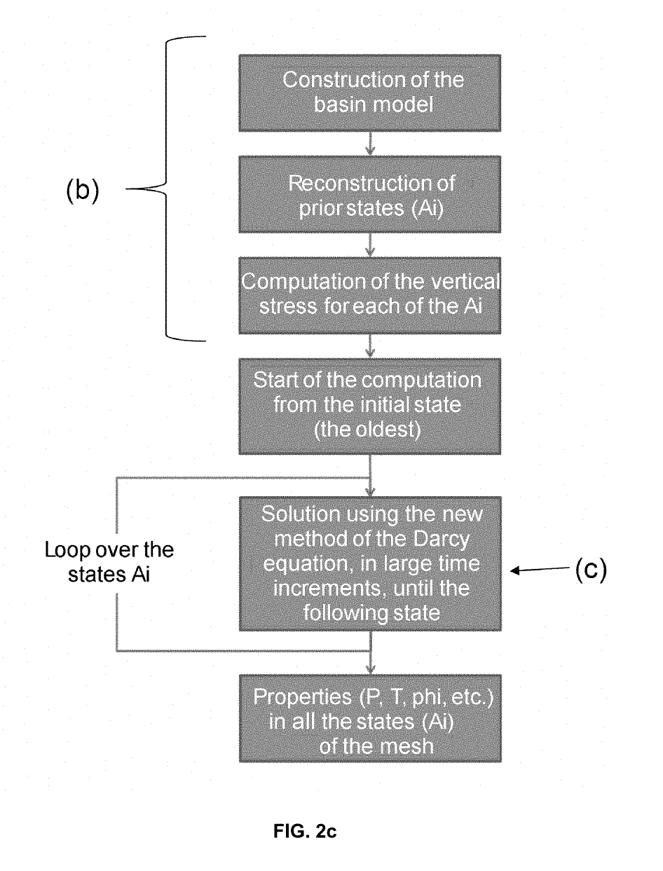

With reference to FIG. 2a, which shows the sequence of a typical method, the computation of the pressure field in a numerical sedimentary basin model is based on the coupled solution, at the scale of the sedimentary basin, of the variation in the vertical stress, of the variation in the porosity of the rocks, of the variation in their permeability and of the variation in their properties (density and viscosity in particular) and of the volumes of fluids.

More precisely, as explained in the introduction, if the set of the states is called {Aᵢ}_{iϵ[[0;n]]}, two states being separated by an event of geological order, then for each state Aᵢ it is necessary to solve the Darcy equation in small time increments (i.e. with a small time interval dt) until the following state Aᵢ₊₁.

Furthermore, while the number of states Aᵢ is in the end relatively limited, it is necessary to have several hundred increments per state in order to obtain a good modeling quality.

In order to determine all of the aforementioned properties, the solution of the equations of conservation of mass coupled to the Darcy equation thus requires computational times that may be very long, from a few minutes to several hours, depending on the dimension of the numerical model (number of cells and number of geological events) and depending on the complexity of the physical and geological effects.

This problem of the complexity of the solution of the Darcy equation is well known to those skilled in the art familiar with algorithmics. It has moreover been proposed in document US published patent application 2010/0223039 to simplify the equations by making assumptions as to the physical effects involved. This is effective but proves to be very complex to manage given the multiplicity of effects and may decrease quality.

In contrast, the present method provides an algorithmic technique allowing the number of times the Darcy equation is solved to be decreased.

According to the invention, the Darcy equation is solved only if it is necessary to do so. More precisely, it has been observed that in a number of cases, the computational time used to solve the Darcy equation may be saved if it is possible to predict the result.

Specifically, in the earliest phases of the geological history of a sedimentary basin, the pressure field is often in hydrostatic equilibrium, that is the overpressure is zero at every point in the basin. It is then possible to directly determine the pressure at every point in the basin without solving the Darcy equation. It is enough to apply the formula:

P_{z}=Pₐₜₘ+ρ_{w}gz,

with P_{z} being the pressure at the depth z, Pₐₜₘ being atmospheric pressure, ρ_{w} being the density of water, and g being the acceleration due to gravity.

In order to generate a pressure that diverges from hydrostatic equilibrium, it is necessary for the volume of fluid to be moved because of changes in geological conditions to be larger than the volume of water that the flow properties allow to be made to flow. Assuming a purely vertical flow of water, it is possible to compute, during each state Aᵢ, in each of the cells of the geological model, the difference between the volume of fluid to be moved and the volume that may actually flow because of the permeability of the rock. It is then possible to determine whether there exists a possible source of abnormal pressure. If no source of abnormal pressure exists (or if the source term is lower than a criterion) during the duration of a state Aᵢ, the basin is then considered to be in hydrostatic equilibrium. If the calculation of this balance is far speedier than the solution of the Darcy equation, it is possible to completely solve the Darcy equation only when this proves to be necessary and thus drastically decreases computation times.

### Architecture

With reference to FIG. 2b, a method for modeling a sedimentary basin, the sedimentary basin having undergone a plurality of geological events defining a sequence of states {Aᵢ} of the basin, with each state extending between two successive geological events, will now be described.

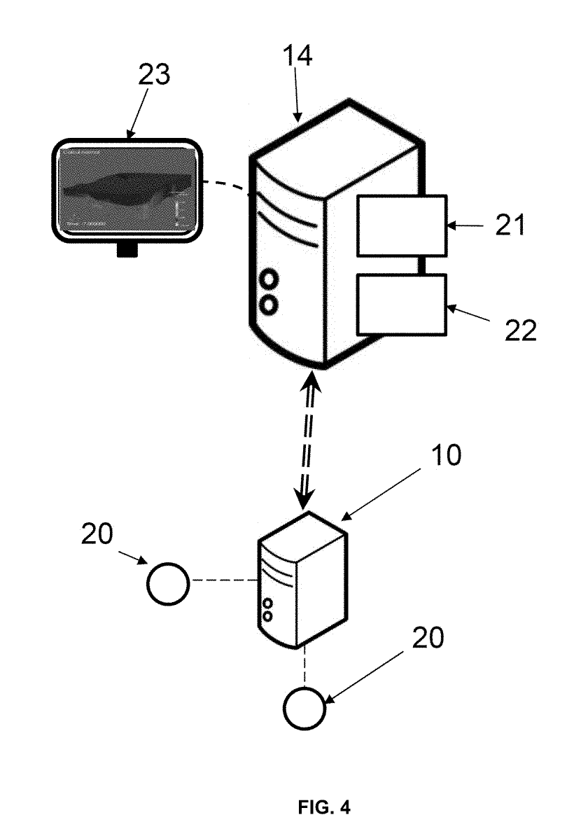

The present method is typically implemented within processing equipment such as shown in FIG. 4 (for example a workstation) equipped with data processing 21 (a processor) and data storage 22 (a memory, in particular a hard disk capability), typically provided with an input/output interface 23 for inputting data and returning the results of the method.

The method uses, as explained, data relating to the sedimentary basin to be studied. The latter may for example be obtained from well logging measurements carried out along wells drilled into the basin under study, from the analysis of rock samples for example at least one of taken by core drilling, and from seismic images obtained following seismic acquisition campaigns.

In a step (a), in a known way, the data processing capability 21 obtained measurements of physical quantities of the basin, which are acquired from sensors 20. Without limitation, the sensors 20 may be well logging tools, seismic sensors, samplers and analyzers of fluid, etc.

Given the length and complexity of seismic, stratigraphic and sedimentological measurement campaigns (and geological campaigns generally), the measurements are generally accumulated via dedicated storage devices 10 allowing such measurements to be gathered from the sensors 20 and stored.

These measurements of physical quantities of the basin may be of many types, and mention is in particular of water heights, of deposited types of sediment, of sedimentation or erosion heights, of lateral stresses at the boundary of the field, of lateral flows at the boundary of the field, etc.

With regard to the choice of the physical quantities of interest, those skilled in the art may refer to the document “Contribution de la mécanique à l'étude des bassins sédimentaires: modélisation de la compaction chimique et simulation de la compaction mécanique avec prise en compte d'effets tectonique”, by Anne-Lise Guilmin, 10 Sep. 2012, Ecole des Ponts ParisTech.

In a step (b), for each of the states Aᵢ, the data processing compatibilty 21 constructs (or reconstruct) a meshed representation of the basin depending on the measurements of physical quantities. The meshed representation models the basin in a set of elementary cells.

As will be seen, it is desirable for step (b) to comprise, for each state, the determination of a total vertical stress on each cell of the meshed representation.

As is known, those skilled in the art will be able to use known backstripping or structural reconstruction techniques to carry out this step. In the rest of the present description, the example of backstripping will be described, but the present method is not limited to anyone particular meshed representation.

Last, in a step (c), the processing capability 21 computes, for each of the states Aᵢ, and for each cell of the meshed representation, an overpressure in the cell at the end of the state Aᵢ by solving an equation of the Darcy equation type. What is meant by equation of the Darcy equation “type” is one of the versions of the Darcy law expressing the flow rate of a fluid filtering through a porous medium, in particular either the normal equation such as presented above, solved conventionally in small increments, or a “simplified” equation, for example the equation that will be presented below, solved in larger increments.

This step is in any case implemented recursively (the overpressure in the cell at the end of the state Aᵢ is calculated depending on the overpressure in the cell at the end of the preceding state Aᵢ₋₁).

Thus, with reference to FIG. 2b, the present method is noteworthy in that step (c) comprises a prior step (c).0 which verifies that, for at least one of the cells, the overpressure has changed during the state Aᵢ by more than at least one preset threshold, and, at the end of which, the rest of step (c) is implemented only if this is verified. Alternatively, if this is not verified, the pressure field is in hydrostatic equilibrium and it is possible to apply the formula: P_{z}=Pₐₜₘ+ρ_{w}gz (i.e. the overpressure is zero everywhere).

As will be seen, two preset thresholds are advantageously used. The first threshold is used for each cell, and if this first threshold is verified everywhere, a second “cumulative error” threshold is tested. Those skilled in the art are capable of determining the values of these thresholds, depending on the expected precision of the estimation of the overpressures.

To implement this verification procedure, a balance between the volume of fluid to be moved and the volume of mobile fluid is carried out for each state Aᵢ. Generally, step (c).0 comprises computing a value of the theoretical overpressure that would develop in the cell under the assumption of a hydrostatic pressure.

It must be understood that the verifying step does not compute the overpressure in the cell at the end of the state Aᵢ, nor even its actual change during the state Aᵢ, but only estimates a theoretical change therein (by virtue of the assumption of a hydrostatic pressure). This theoretical value is easy to compute and is representative of the actual value. This is a reliable test of determining whether or not to solve the Darcy equation.

In other words, step (c) of the present method comprises a step (c).0 in which a first overpressure value is computed, while assuming that the overpressure in the cell is of hydrostatic origin (that is this first overpressure value corresponds to the pressure that a column of water would create at the same depth as the cell in question), then if this first overpressure has changed during the state Aᵢ by more than at least one preset threshold, a second overpressure value is calculated in the cell in question using a law expressing the flow rate of a fluid filtering through a porous medium (or in other words an optionally simplified Darcy law). In yet other words, the method according to the invention is noteworthy in that first of all an approximate estimation of the overpressure in each cell is determined (by use of an approximate model, based on an assumption that the overpressure is uniquely of hydrostatic origin), and if this computation reveals that the overpressure as approximately estimated is higher than a preset first threshold, then the overpressure in the cell in question is computed more precisely (by means of a precise model such as the Darcy equation, whether simplified or not).

As explained, a second cumulative error threshold (or total error threshold) may be used. In other words, step (c).0 advantageously furthermore comprises verifying that for at least one of the cells the overpressure has changed, from the last state A_{j,j<i} in which the rest of step (c) was implemented, by more than a second preset threshold. It must be understood that the two verifications are cumulative so that if at least one of the tests is verified (single error above the first threshold OR cumulative error above the second threshold), the Darcy equation is solved, and if none of the tests is verified (single error below the first threshold AND cumulative error below the second threshold), the Darcy equation is not solved.

In a particularly preferred way, for this total error test “indicators” associated with each of the cells, which indicators will be described below, are used. These indicators allow the small theoretical overpressures that are ignored to be summed so as to force the Darcy equation to be solved at the end of a certain time when the total error is no longer acceptable. More precisely, if for all the cells the rest of step (c) is not implemented (that is if a computed theoretical overpressure value is lower than the first threshold), then the indicator is incremented, and if it is implemented for at least one cell, the indicators are reset to 0.

In summary, step (c).0 advantageously comprises computing, for each cell, an indicator:
If for each cell the computed value of the theoretical overpressure that would develop in the cell under the assumption of a hydrostatic pressure is lower than the first threshold, each indicator is incremented by the computed value of the theoretical overpressure that would develop in the (corresponding) cell under the assumption of a hydrostatic pressure;
If for at least one cell the computed value of the theoretical overpressure that would develop in the cell under the assumption of a hydrostatic pressure is lower than the first threshold or the value of the indicator (associated with the cell) is higher than the second threshold, each indicator is reset to zero.

To use yet other words, step (c) comprises, for each of the states Aᵢ, and for each cell of the meshed representation, the verification that, for at least one of the cells, an overpressure has changed during the state Aᵢ by more than a first preset threshold (and advantageously the additional verification that for at least one of the cells the overpressure has changed, from the last state A_{j,j<i} in which the rest of step (c) was implemented, by more than a second preset threshold), and if (and only if) this (at least one of the two verifications) is verified, the overpressure in the cell at the end of the state Aᵢ is computed by solving a Darcy equation.

According to one particularly preferred embodiment:
a. In the first state Aₒ, the indicator that will be used to determine the method used to compute the pressure term (hydrostatic pressure or by actual solution of an equation of the Darcy equation type) is initialized to zero in each cell.
b. For each state Aᵢ:
   i. The volume of fluid that must flow because of changes in the geological conditions in the cell in order to preserve a medium saturated with fluid is first computed for each cell of the model. This value corresponds to the difference in volume of the cell during the duration of the state Aᵢ, for example determined by the backward structural restoration method (backstripping method for the implementation of step (b)). This volume is negative in the case where the volume of the cell increases.
   ii. A value of the overpressure, oPⁱ, that would develop in the cell if the latter followed exactly the variation in volume given by the backward computation (i.e. under the assumption of a hydrostatic pressure) is estimated.

$$V = q \times Δ t \times S = \frac{V}{Δ \tilde{σ}} \times oP + \frac{k}{μ} \times S \times \frac{{oP}^{i}}{d} \times Δ t ,$$

It will in particular be noted that if k (the permeability in m² of the cell at the start of the state) is very small, it is indeed true that oP=Δ\tilde{σ},

With:

V is the flow speed of the water (m/s);

Δ\tilde{σ} is the effective stress change (Pa);

k is the permeability (m²);

q is the Darcy or filtration speed (m/s);

oPⁱ is the theoretical overpressure generated during the state (kg/m/s²) (the latter may be negative when the difference in volume is negative);

μ is the dynamic viscosity (kg/m/s) of water;

S is the area of the cell normal to the vertical axis (in m²);

d is the distance between the center of the cell and the center of the top face of the cell (in m);

g is the norm of the acceleration due to gravity vector (m/s²); and

Δt is the duration of the state (in s).
iii. The term oPⁱ is compared, for each cell of the model, with the first preset threshold. This threshold corresponds to the acceptable error in the estimation of the overpressure between two states of the sedimentary basin.
   1. If no cell exceeds the criterion, that is the absolute value of oPⁱ remains lower than or equal to the first threshold, then the value of the indicator in each of the cells is incremented by oPⁱ. The indicator is then compared with an (empirical) second preset threshold corresponding to the total “acceptable” error.
      a. If this second threshold is not exceeded, the pressure is not computed by solving an equation of the Darcy equation type. It is assumed that during this state Aᵢ the overpressure has not varied from the preceding state Aᵢ₋₁. Specifically, this situation expresses the fact that the geological conditions allow the changes in volume of rock in the basin to be handled without a priori modification of the overpressure (depending on the criteria used).
   2. If at least one of the two thresholds is not respected in at least one of the cells of the model, it is necessary to solve the Darcy equation (step (c)) in order to determine the overpressure distribution in the sedimentary basin. The value of the indicator is then reset to zero in all of the model.

Conventionally, step (c) will possibly moreover comprise the numerical simulation (where appropriate over a shorter time interval) of at least one physical effect so as to estimate, apart from the overpressure, any quantity of the sedimentary basin that could possibly be of interest to those skilled in the art, such as fluid saturations, temperatures, etc.

### Preferred Embodiment

Particularly preferably, with reference to FIG. 2c, the present method uses, in step (c) (when it must be implemented) a “simplified” version of the Darcy equation that may be solved using a substantially larger time interval (thereby therefore allowing the number of iterations required for each state to be decreased).

As will be seen, a single “large” increment may be sufficient for one state, and at worst a few tens of increments will suffice, this decreasing at least by one order of magnitude the number of iterations required to implement the method, and furthermore greatly simplifying algorithmic complexity.

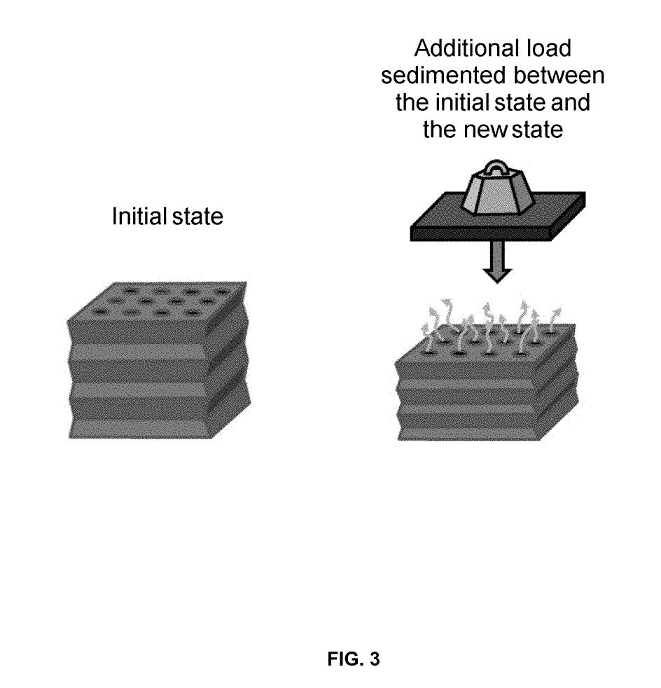

This implementation of the invention is based on a decoupling of the deposition and erosion processes (increase or decrease in the sedimentary load) and of those of the flow of the fluids (creation/dissipation of the overpressure), as is illustrated in FIG. 3, which will be described in more detail below.

More precisely, instead of considering the sedimentary load and the overpressure to be two interdependent parameters that it is necessary to solve simultaneously (hence the many increments required in each state), it will be shown that it is possible to determine a priori the change in effective stress between two geological events (and therefore over an entire state Aᵢ), and then, for this state Aᵢ, to estimate the overpressure on the basis of the estimated variation in the effective stress.

In this particular preferred embodiment, step (c) comprises, as explained, steps (c).1 and (c).2, which will be implemented recursively for each of the states A. In the rest of the present description, the example of a single time increment per state Aᵢ (that is length of the time interval=length of the state) will be taken, this most often being enough; but it will be understood that if the circumstances require it, those skilled in the art will possibly place a plurality of increments in one state (that is compute intermediate values of the effective stress and overpressure) if for example it is of a particularly long duration. In practice, the increments will be 5 to 100 times longer, and the number of computational steps divided accordingly.

Generally, a step (c) then comprises, for each of that states Aᵢ, and each cell of the meshed representation:
1. Computing an effective stress applied to the cell at the end of the state Aᵢ;

2. Computing an overpressure in the cell at the end of the state Aᵢ depending on said effective stress.

As will be seen, the recursive character is due to the fact that the computation of an effective stress applied to the cell at the end of the state Aᵢ advantageously involves the value of the effective stress at the end of the preceding state Aᵢ₋₁, and the fact that the computation of the overpressure advantageously involves the value of the effective stress at the end of the preceding state Aᵢ₋₁ and of the present state Aᵢ and the value of the overpressure in the cell at the end of the preceding state Aᵢ₋₁.

This may be summarized as follows:
1. computation of an effective stress applied to the cell at the end of the state Aᵢ on the basis of the effective stress applied to the cell at the end of the preceding state Aᵢ₋₁;
2. computation of an overpressure in the cell at the end of the state Aᵢ depending on the effective stresses applied to the cell at the end of the state Aᵢ and at the end of the preceding state Aᵢ₋₁, and on the overpressure in the cell at the end of the preceding state Aᵢ₋₁.

Step (c).1 is a step of computing effective stresses applied to the basin. More precisely, the effective stress at the end of the state Aᵢ is computed for each cell of the meshed representation, and for each state Aᵢ.

Step (c).1 thus allows the change in effective stress between two geological events (that is during a state Aᵢ) to be determined a priori. Knowing the effective stress in each cell of the model at the start of the state Aᵢ in question (equal to that at the end of the preceding state Aᵢ₋₁), denoted σᵢₙᵢₜᵢₐₗ, an additional effective stress denoted σ_{eff}_{_}_{add} is computed, which is added to the stress σᵢₙᵢₜᵢₐₗ in order to obtain σ_{eff}.

According to one embodiment of the invention, the effective stress corresponds to the lithostatic stress. The vertical stress corresponding to the weight of the superjacent rocks is called the lithostatic stress. The additional lithostatic stress thus corresponds to the variation in the weight of the superjacent rocks during the state Aᵢ, that is the deposition or erosion.

The thickness of sediment deposited or eroded during the same state Aᵢ is also known.
In the case of a sedimentary deposition, step (b) delivers the additional total vertical stress Δσᵥ (difference between the total vertical stresses at the end of the state Aᵢ in question and the preceding state Aᵢ₋₁, respectively) and the theoretical additional effective stress Δ\tilde{σ} under the assumption that these additional sediments are at hydrostatic pressure (this generally being the case because these freshly deposited sediments are generally very porous and very permeable).
In the case of an erosion, the additional total vertical stress Δσᵥ and the theoretical additional effective stress Δ\tilde{σ} of the removed portion of the sedimentary column are known by virtue of the computation carried out in the preceding state Aᵢ₋₁.

In other words, knowing the solid volume of the additional load, the backstripping (step (b)) gives its porosity under the assumption of hydrostatic pressure. The additional total load (additional stress) is therefore known and the additional effective stress (total load—hydrostatic pressure equivalent to the sedimented thickness) σ_{eff}_{_}_{add} is deduced therefrom.

It is then possible to compute, from the effective stress, in step (c).2, the overpressure, because, at each point of the sedimentary column, the variation in the effective stress is then the sum of Δ\tilde{σ}, which is uniform over the entire column, and of the change in overpressure at the point in question (which therefore corresponds to the divergence from the hydrostatic pressure).

In this step (c).2, the data processing capability 21 thus estimates the overpressure at the end of the geological state Aᵢ in question on the basis of the change in effective stress estimated in the preceding step.

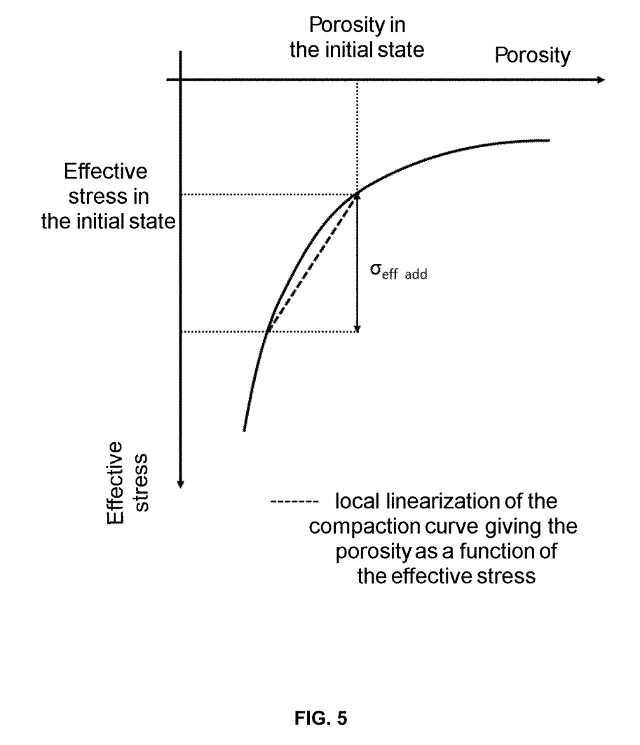

The difficulty is to locally linearize the curve of the variation in the porosity as a function of the load, as may be seen in FIG. 5. This is the key point that allows the Darcy equation to be solved for a large time interval (of as large as the entire length of the state Aᵢ), and not in small increments of movement over this curve.

The underlying assumption is that the rate of change in the porous volume is constant during the state Aᵢ and thus a linear variation in the porous volume with respect to the overpressure is obtained. This allows the latter to be rapidly estimated with a “simplified” Darcy equation directly relating the overpressure at the start and end of the state Aᵢ, according to the following formula:

$$\frac{{Vol}_{s , k}}{Δ t} {c}_{k} ( {oP}_{k}^{i} - {oP}_{k}^{i - 1} ) + {\int }_{δ k}^{ } \frac{- K}{μ} \vec{grad} {oP}_{k}^{i} \cdot {\vec{n}}_{k} = - \frac{{Vol}_{s , k}}{Δ t} Δ \tilde{σ} {ϵ}_{k} ,$$

With:

Cₖ is the change in void density (porous volume over solid volume) over the change in effective stress under the assumption of hydrostatic pressure;

Vol_{s,k} is the solid volume of the cell k in question;

μ is the kinematic viscosity of the fluid;

K is the intrinsic permeability of the rock;

Δt is the duration of the state in question;

oPᵢ is the overpressure at the end of the state Aᵢ;

Δ\tilde{σ}ϵ is the theoretical additional effective stress under the assumption that these additional sediments have a hydrostatic pressure.

In summary, step (c).2 advantageously comprises computing a rate of change in the effective stress during the state Aᵢ depending on the effective stress at the end of the state Aᵢ and on the effective stress at the end of the preceding state Aᵢ₋₁.

### Return

At the end of step (c), which is repeated for each cell and for each state Aᵢ, at least the value of the overpressure in each cell at the current time is obtained.

Furthermore, depending on the basin simulator used to implement the invention, additional information may be obtained on the formation of the sedimentary layers, their compaction under the effect of the weight of superjacent sediments, the heating thereof during their burial, the formation of hydrocarbons by thermal generation, the movement of these hydrocarbons in the basin under the effect of floatability, of capillary action, of differences in at least one of the pressure gradients, and the subterranean flows, and the amount of hydrocarbons produced by thermal generation in the cells of said meshed representation of said basin

Based on such information, it is possible to identify regions of the basin, corresponding to cells of the meshed representation at the current time of the basin, containing hydrocarbons, and the content, the nature and the pressure of the hydrocarbons that are trapped therein. Those skilled in the art will then be able to select the regions of the studied basin having the best oil and gas potential.

The development of the basin for oil and gas purposes may then take a number of forms, in particular:
exploration wells may be drilled into the various regions selected as having the best potential, in order to confirm or disprove the potential estimated beforehand, and to acquire new data to feed to new, more precise studies, and
development wells (production or injection wells) may be drilled in order to recover hydrocarbons present within the sedimentary basin in regions selected as having the best potential.

The method thus preferably comprises a step (d) of selecting regions of the basin corresponding to cells of the meshed representation of the basin of at least one of at the current time containing hydrocarbons, and development of the basin depending on the selected regions.

Alternatively or in addition, step (d) may comprise the return to the interface 23 of information on the well, such as a visual representation as will now be described.

### Result

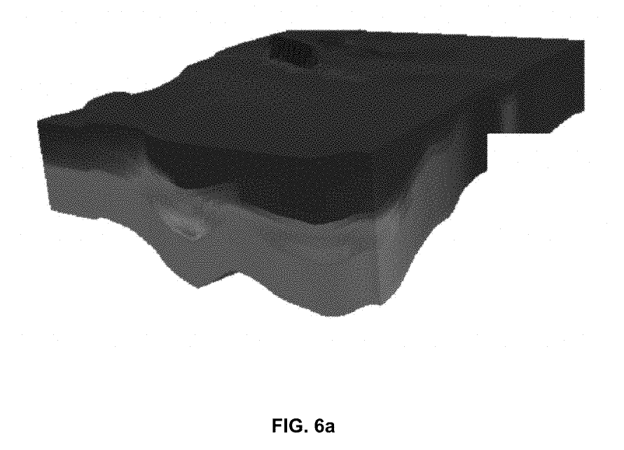

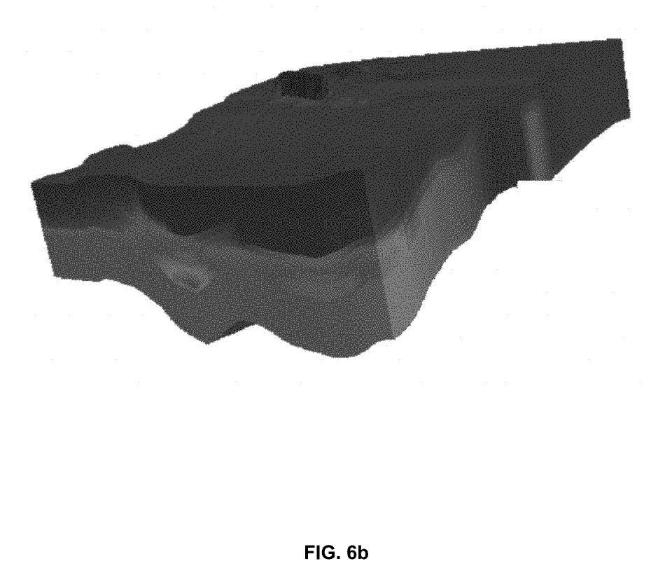

Purely by way of illustration, FIGS. 6a and 6b show the models of a sedimentary basin (the overpressure value computed for each cell is shown) obtained by implementing a conventional method and a method according to the invention.

The modeling qualities may be seen to be similar (identical patterns have been generated) whereas the simulation times were very different. In the case of the conventional method (FIG. 6a), this time was 24 minutes 31 seconds, whereas only 3 minutes 26 seconds were required in the case of the method according to the invention (FIG. 6b). With the same computational resources and modeling quality, a time-saving of a factor of 7 was observed.

### Equipment and Computer Program Product

According to a second aspect, equipment 14 for implementing the present method for modeling a sedimentary method is provided.

This equipment 14 comprises, as explained, data processing capability 21, and advantageously data storage 22, and an interface 23.

The data processing capability 21 are is configured to:
Obtain measurements of physical quantities of the basin, which are acquired from sensors 20;
For each of the states Aᵢ, a meshed representation of the basin depending on the measurements of physical quantities is constructed;
For each of the states Aᵢ, and for each cell of the meshed representation, verifying that for at least one of the cells an overpressure has changed during the state Aᵢ by more than a first preset threshold, and if this is verified computing the overpressure in the cell at the end of the state Aᵢ by solving a Darcy equation.

According to a third aspect, the invention also relates to a computer program product which at least one of downloadable from a communication network, recorded on a tangible medium that is readable by computer executable by a processor, comprising program code instructions for implementing the method according to the first aspect, when the program is executed on a computer.

1.-15. (canceled)

16. A method for modeling a sedimentary basin, which has undergone a plurality of geological events defining a sequence of states of the basin, each of the states extending between two successive geological events, the method comprising implementation by data processing of steps of:
(a) obtaining measurements of physical quantities of the basin which are acquired from sensors;
(b) for each of the states, constructing a meshed representation of the basin depending on the measurements of the physical quantities; and
wherein:
(c) for each of the states and for each cell of the meshed representation computing a first overpressure in the cell based on an assumed hydrostatic pressure, and if the first overpressure has changed during the state by more than a first preset threshold in the cell, computing a second overpressure in the cell at the end of the state by solving a law expressing a flow rate of a fluid filtering through a porous medium.

17. The method as claimed in claim 16, wherein the first overpressure is obtained using the formula
$$V = q \times Δ t \times S = \frac{V}{Δ \tilde{σ}} \times oP + \frac{k}{μ} \times S \times \frac{{oP}^{i}}{d} \times Δ t ,$$
wherein:
V is a flow speed of water;
Δσ is an effective stress change;
k is a permeability;
q is a Darcy or filtration speed;
oPⁱ is a first overpressure generated during the state;
μ is a dynamic viscosity of water;
S is an area of the cell normal to the vertical axis;
d is a distance between the center of the cell and the center of the top face of the cell;
g is a norm of the acceleration due to gravity vector;
Δt is a duration of the state in question.

18. The method as claimed in claim 16, comprising verifying that for at least one of the cells the first overpressure has changed, from a last state in which a remaining part of step (c) was implemented, by more than a second preset threshold.

19. The method as claimed in claim 17, comprising verifying that for at least one of the cells the first overpressure has changed, from a last state in which a remaining part of step (c) was implemented, by more than a second preset threshold.

20. The method as claimed in claim 16 comprising computing for each cell an indicator wherein:
if for each cell a computed value of the first overpressure that would develop in the cell under the assumed hydrostatic pressure is lower than the first threshold, each indicator is incremented by the computed value of the first overpressure that would develop in the cell under the assumed hydrostatic pressure; and
each indication is reset to zero if for at least one cell the computed value of the first overpressure that would develop in the cell under the assumed hydrostatic pressure is lower than the first threshold or a value of the indicator is higher than the second threshold.

21. The method as claimed in claim 17 comprising computing for each cell an indicator wherein:
if for each cell a computed value of the first overpressure that would develop in the cell under the assumed hydrostatic pressure is lower than the first threshold, each indicator is incremented by the computed value of the first overpressure that would develop in the cell under the assumed hydrostatic pressure; and
each indication is reset to zero if for at least one cell the computed value of the first overpressure that would develop in the cell under the assumed hydrostatic pressure is lower than the first threshold or a value of the indicator is higher than the second threshold.

22. The method as claimed in claim 18 comprising computing for each cell an indicator wherein:
if for each cell a computed value of the first overpressure that would develop in the cell under the assumed hydrostatic pressure is lower than the first threshold, each indicator is incremented by the computed value of the first overpressure that would develop in the cell under the assumed hydrostatic pressure; and
each indication is reset to zero if for at least one cell the computed value of the first overpressure that would develop in the cell under the assumed hydrostatic pressure is lower than the first threshold or a value of the indicator is higher than the second threshold.

23. The method as claimed in claim 19 comprising computing for each cell an indicator wherein:
if for each cell a computed value of the first overpressure that would develop in the cell under the assumed hydrostatic pressure is lower than the first threshold, each indicator is incremented by the computed value of the first overpressure that would develop in the cell under the assumed hydrostatic pressure; and
each indication is reset to zero if for at least one cell the computed value of the first overpressure that would develop in the cell under the assumed hydrostatic pressure is lower than the first threshold or a value of the indicator is higher than the second threshold.

24. The method as claimed in claim 16, comprising:
(d) selecting regions of the basin corresponding to cells of the meshed representation of the basin at a current time which contain hydrocarbons.

25. The method as claimed in claim 24, wherein step (d) comprises developing the basin depending on the selected regions.

26. The method as claimed in claim 16, comprising performing step (b) by backstripping or structural reconstruction.

27. The method as claimed in claim 16, wherein step (c) comprises:
computing an effective stress applied to the cell at the end of the state; and
computing the second overpressure in the cell at the end of the state depending on the effective stress computed at the end of the state.

28. The method as claimed in claim 27, comprising:
computing the effective stress at the end of the state for a cell dependent on the effective stress at the end of a preceding state and on an additional effective stress based on the preceding state dependent on a change in thickness of the sediment during the state.

29. The method as claimed in claim 28, wherein step b) comprises, for each cell and each state, determining a total vertical stress on the cell, an additional effective stress computed in step (c) the additional total vertical stress with respect to a preceding state minus a hydrostatic pressure equivalent of a change in thickness of the sediment.

30. The method as claimed in claim 27, comprising:
computing a rate of change in effective stress during the state depending on effective stress at the end of the state and on the effective stress at the end of a preceding state.

31. The method as claimed in claim 30, comprising:
computing a rate of change in a porous volume of the cell during the state while assuming a rate of change in effective stress during the state to be constant, for obtaining a second overpressure at an end of the state by solving a Darcy equation.

32. The method as claimed in claim 31, wherein the Darcy equation is given by the formula
$$\frac{{Vol}_{s , k}}{Δ t} {c}_{k} ( {oP}_{k}^{i} - {oP}_{k}^{i - 1} ) + {\int }_{δ k}^{ } \frac{- K}{μ} \vec{grad} {oP}_{k}^{i} \cdot {\vec{n}}_{k} = - \frac{{Vol}_{s , k}}{Δ t} Δ \tilde{σ} {ϵ}_{k} ,$$
wherein
Cₖ is a change in void density over a change in effective stress under an assumption of hydrostatic pressure;
Vol_{s,k} is a solid volume of the cell k in question;
μ is a kinematic viscosity of the fluid in the basin;
K is an intrinsic permeability of the rock in the basin;
Δt is a duration of the state;
oPⁱ is a second overpressure at the end of the state; and
Δ\tilde{σ}ϵ is a theoretical additional effective stress.

33. Processing equipment for modeling a sedimentary basin which has undergone geological events defining a sequence of states of the basin, each state extending between two successive geological events, the equipment configured to perform data processing by to:
obtaining measurements of physical quantities of the basin which are acquired from sensors;
constructing for each of the states, a meshed representation of the basin depending on the measurements of the physical quantities; and
verifying for each of the states, and for each cell of the meshed representation that for at least one of the cells a first overpressure computed under an assumed hydrostatic pressure that has changed during the state by more than a first preset threshold, and if the assumed hydrostatic pressure charge is verified computing a second overpressure in the cell at an end of the state by solving a Darcy equation.

34. A computer program non transiently recorded on a tangible recording medium comprising program code instructions for implementing the method as claimed in claim 16 when the program is executed on a computer.
